(19) United States
(12) Patent Application Publication
(10) Pub. No.: US 2016/0234696 A1
(43) Pub. Date: Aug. 11, 2016

(54) DETECTION OF COEXISTENCE IN DEVICES USING MULTIPLE WIRELESS COMMUNICATION TECHNOLOGIES

(71) Applicant: Qualcomm Technologies International, Ltd., Cambridge (GB)

(72) Inventors: Nicholas Looker, Cambridge (GB); John Franklin, Cambridge (GB); Ruchi Rajpal, Cambridge (GB); Kanwalpreet Chanana, Cambridge (GB); Rohit Girhotra, Cambridge (GB)

(21) Appl. No.: 14/617,007

(22) Filed: Feb. 9, 2015

(51) Int. Cl. H04W 24/02; H04B 1/44; H04W 72/04

(52) U.S. Cl. CPC H04W 24/02; H04W 72/0446; H04B 1/44; H04W 88/06

(57) ABSTRACT

Methods are provided for detecting a wireless coexistence scenario in which two peer devices in communication with each other are both operating a coexistence management mechanism. The detection of this wireless coexistence scenario may be used to provide a trigger to change the coexistence management mechanism so as to prevent interference.

### BACKGROUND

This disclosure concerns wireless coexistence in electronic devices that use wireless communication, and, in particular, the management of wireless coexistence to prevent conflicts such as interference.

Electronic devices equipped with wireless communication functionality are increasingly able to operate using two or more independent (typically different) wireless communication (radio frequency (RF)) technologies, which may have different communication protocols. Wireless coexistence may occur when such a device communicates using two independent wireless communication technologies that use the same or adjacent radio frequency bands simultaneously, and, a coexistence management mechanism (e.g., arbitration algorithm) should be used to prevent mutual interference between the different RF signals.

Typically, a first device capable of communicating using two different wireless communication technologies communicates with two different peer devices, each of which can only communicate using one of the wireless communication technologies as shown in FIG. 1. In this case, the wireless coexistence management mechanism in the first device operates to allow coexistence, typically time-domain based coexistence, without interference. However, a problem arises when communication is established between two electronic devices both communicating using two different wireless communication technologies as shown in FIG. 2. In particular, interference may occur due to conflicts arising in the coexistence management mechanisms (e.g., arbitration algorithms) operating in the two devices.

There is a need to more effectively manage wireless coexistence to prevent interference occurring, particularly when two devices are communicating with each other using two different wireless communication technologies employing different communication protocols.

### SUMMARY

This Summary of the disclosure is provided to introduce a selection of concepts in a simplified form that are further described below in the Detailed Description. This Summary is not intended to identify key or essential features of the claimed subject matter, nor is it intended to be used as an aid to determining the scope of the claimed subject matter.

Methods are provided for detecting a wireless coexistence scenario in which two devices in communication with each other are both operating a coexistence management mechanism or algorithm. The detection of this wireless coexistence scenario may be used to provide a trigger to switch to an alternative coexistence management mechanism to prevent conflicts, which may disable a coexistence management mechanism operating in one of the devices, thereby preventing interference.

In one aspect, a method for wireless coexistence management is provided. The method is performed using a first device and comprises the steps of: monitoring signal samples of communications in accordance with first and second independent wireless communication technologies over a predetermined time period, the signal samples comprising samples of wireless communications between the first device and at least one peer device; processing the monitored signal samples to determine whether the monitored communications indicate the probable existence of a wireless coexistence scenario, in which the first device is communicating with a single peer device in accordance with both the first and second wireless communication technologies, and if the step of processing the monitored signal samples determines that the monitored communications indicate the probable existence of the wireless coexistence scenario, triggering a wireless coexistence management process.

In implementations of the method, the wireless coexistence management process comprises changing the wireless coexistence management mechanism operating in one of the first device, the peer device or both in order to prevent wireless coexistence problems. For example, the wireless coexistence management process may involve switching off the wireless coexistence mechanism in one of the first device and the peer device.

Changing the wireless coexistence management mechanism operating in one of the first device, the peer device or both may be accomplished by either making a decision locally on the first device, or using the first wireless communication technology or the second wireless communication technology to signal to the peer device and coordinate coexistence management activity.

In implementations, the step of processing the monitored signal samples to determine whether the monitored communications indicate the probable existence of the wireless coexistence scenario comprises: sampling signals of communications in accordance with the first and second wireless communication technologies for a predetermined time period, each signal sample comprising signals communicated during a predefined sampling period; and, for each signal sample: determining whether a valid received (Rx) signal in accordance with the first wireless communication technology is communicated during a predefined time slot (or trigger period) of the sampling period; determining whether a valid transmitted or received (Tx/Rx) signal in accordance with the second wireless communication technology is communicated during the predefined time slot of the sampling period, and if it is determined that both a valid received (Rx) signal in accordance with the first wireless communication technology and a valid transmitted or received (Tx/Rx) signal in accordance with the second wireless communication technology are communicated during the predefined sampling period, determining that the monitored communications do not indicate the probable existence of the wireless coexistence scenario.

The method may further comprise the steps of: prior to the step of monitoring signal samples, determining the predetermined time period for sampling a selected number of signal samples to be processed in order to indicate the probable existence of the wireless coexistence scenario to a predetermined degree of certainty, wherein: if, for a predetermined proportion of the selected number of signal samples, it is not determined that both a valid received (Rx) signal in accordance with the first wireless communication technology and a valid transmitted or received (Tx/Rx) signal in accordance with the second wireless communication technology are communicated during the predefined sampling period, determining that the monitored communications indicate the probable existence of the wireless coexistence scenario to the predetermined degree of certainty. The predefined time slot of the sampling period may comprise a known receive (Rx) time slot for signals communicated in accordance with the first wireless communication technology.

In implementations, the selected number of signal samples is determined to provide a statistically meaningful sample size for determining the probability of the wireless coexistence scenario to an acceptable degree of certainty for the relevant application. This will vary with application requirements.

In certain, active implementations, the method may further comprise the step of: prior to the step of monitoring the signal samples, transmitting a signal in accordance with the first communication technology in order to provoke a response from at least one peer device. Transmission of the signal in accordance with the first communication technology may further be timed so that a response from at least one peer device is received during a known time slot for signals received in accordance with the second communication technology. The signal transmitted in accordance with the first communication technology may comprise a NULL packet or other similar packet.

In such active implementations, the method may further comprise the steps of: prior to the step of transmitting a signal in accordance with the first communication technology, identifying a time slot for the transmission of the signal; determining whether there is sufficient time to send the signal within the identified time slot, and if it is determined that there is sufficient time to send the signal, determining a correct time for transmitting the signal; wherein the step of transmitting a signal in accordance with the first communication technology is performed at the determined correct time so that a response from at least one peer device is received during the predefined time slot of the sampling period.

In the case of a first wireless communication technology in which multiple devices must contend for the transmission medium, the method may further comprise: contending for a transmission medium for communication in accordance with the first communication technology, prior to the step of transmitting a signal in accordance with the first communication technology. In some implementations, the method may further comprise the step of contending for a transmission medium comprises reserving the transmission medium for a desired time period.

In yet another aspect, a method is provided for detecting a wireless coexistence scenario in which two peer devices in communication with each other are both operating a coexistence management mechanism. The method comprises actively transmitting a communication, in accordance with one of two independent communication technologies, for provoking a desired response. The method further comprises passively monitoring wireless communications in accordance with the two communication technologies received in response. The methods further comprise determining whether the monitored communications indicate that the wireless coexistence scenario exists.

In one implementation, a method is provided for determining that the wireless coexistence scenario exists based on processing of signals received in response to the active transmission for provoking a desired response.

In another implementation, the method comprises determining a time or time period for the transmission of the communication to provoke a desired response in a predetermined time period or at a predetermined time. In this way, the timing of the transmission can be controlled to provoke the desired response so that the existence of the wireless coexistence scenario may be determined quickly (within a desired time period) and/or to a high degree of certainty.

In another aspect, a method for determining the probable existence of a wireless coexistence scenario, in which two devices are communicating with each other using first and second independent wireless communication technologies, is provided. The method is performed using a first device and comprises the steps of: sampling signals in accordance with the first and second wireless communication technologies for a predetermined time period, each signal sample comprising signals communicated during a predefined sampling period; and, for each signal sample: determining whether a valid received (Rx) signal in accordance with the first wireless communication technology is communicated during a predefined time slot (or trigger period) of the sampling period; determining whether a valid transmitted or received (Tx/Rx) signal in accordance with the second wireless communication technology is communicated during the predefined time slot of the sampling period, and if it is determined that both a valid received (Rx) signal in accordance with the first wireless communication technology and a valid transmitted or received (Tx/Rx) signal in accordance with the second wireless communication technology are communicated during the predefined sampling period, determining that the monitored communications do not indicate the probable existence of the wireless coexistence scenario.

It will be appreciated that the steps of the methods according to the disclosure may be implemented in real-time by directly monitoring/sampling appropriate signals in accordance with the first wireless communication technology and the second wireless communication technology. The methods may also be implemented by recording (i.e., storing in memory) signal samples for the first wireless communication technology and the second wireless communication technology. In the latter case, the steps of the methods may be applied to the stored data sets at a later time, for example at the end of a predetermined sampling period.

Other aspects of the disclosure will be apparent, from the following detailed description and the accompanying claims.

### BRIEF DESCRIPTION OF THE DRAWINGS

Embodiments that represent implementations of this disclosure will now be described, by way of example, with reference to the accompanying drawings, in which:

FIG. 1 shows a first example of a wireless coexistence scenario;

FIG. 2 shows a second example of a wireless coexistence scenario;

FIGS. 3A and 3B are flow diagrams showing a method for identifying the wireless coexistence scenario of FIG. 2 in accordance with a first example implementation of the present disclosure;

FIGS. 4A and 4B are flow diagrams showing a method for identifying the wireless coexistence scenario of FIG. 2 in accordance with a second example implementation of the present disclosure;

FIG. 5A is a schematic diagram of typical traffic signals communicated in accordance with the scenario of FIG. 1 and FIG. 5B is a schematic diagram of typical traffic signals communicated in accordance with the scenario of FIG. 2;

FIG. 6 is a flow diagram showing a method for identifying the wireless coexistence scenario 2 in accordance with a third example implementation of the present disclosure;

FIG. 7 is a timing diagram of example Wi-Fi and Bluetooth signals showing the time slots of a typical time-domain based coexistence scheme for 2.4 GHz Wi-Fi and Bluetooth;

FIG. 8 is a schematic diagram showing the timings of an average NULL/ACK exchange;

FIG. 9 is a timing diagram showing the timings of the time slots of the example Wi-Fi and Bluetooth signals of FIG. 7, and

FIG. 10 is a timing diagram showing the timings of example Wi-Fi and Bluetooth signals of FIG. 7 in which the RTS/CTS medium reservation mechanism is used.

Common reference numerals are used throughout the drawings to denote the same or similar features.

### DETAILED DESCRIPTION

Embodiments of this disclosure are described below by way of example only. These examples represent the best implementations of the disclosure presently contemplated by the applicant. Nevertheless, numerous other implementations, for putting the disclosure into practice, may be used and are within the scope of the invention.

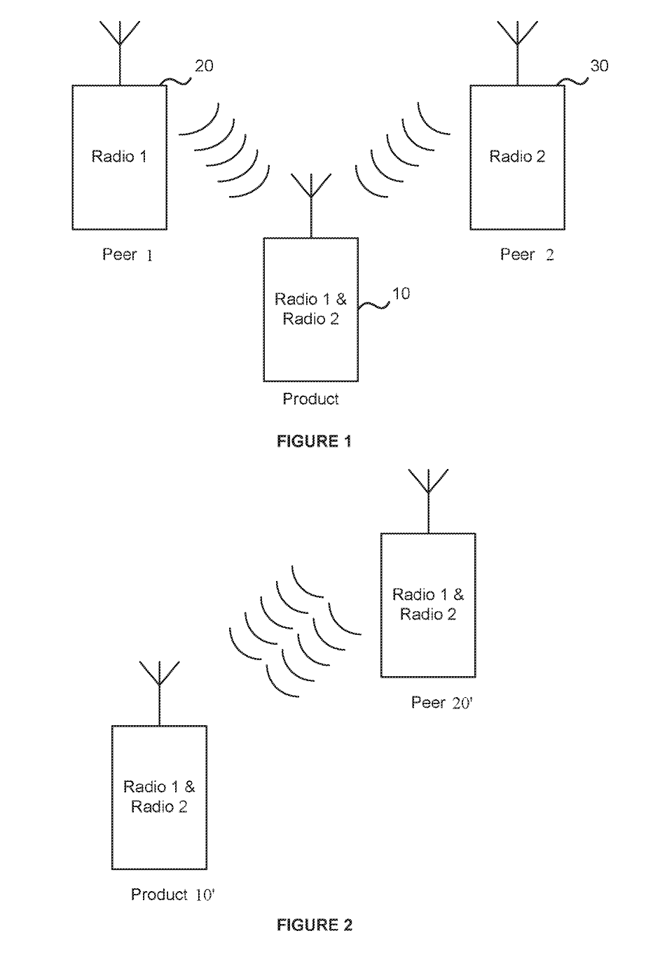

FIG. 1 shows a first example of a wireless coexistence scenario. In this example, a first device 10 (Product) is capable of communicating using two different wireless communication technologies, i.e., Radio 1 and Radio 2. Second and third devices 20, 30 (Peer 1 and Peer 2) are each capable of communicating using only one wireless communication technology, namely Radio 1 and Radio 2, respectively. In this case, a conventional wireless coexistence management mechanism (e.g., arbitration algorithm) in the first device 10 operates to allow coexistence without interference. For example, the wireless coexistence management mechanism may be an arbitration scheme as defined in IEEE standard 802.15.2-2003 “Coexistence of Wireless Personal Area Networks with Other Wireless Devices Operating in Unlicensed Frequency Bands, so as to prevent interference between the Radio 1 and Radio 2 signals”.

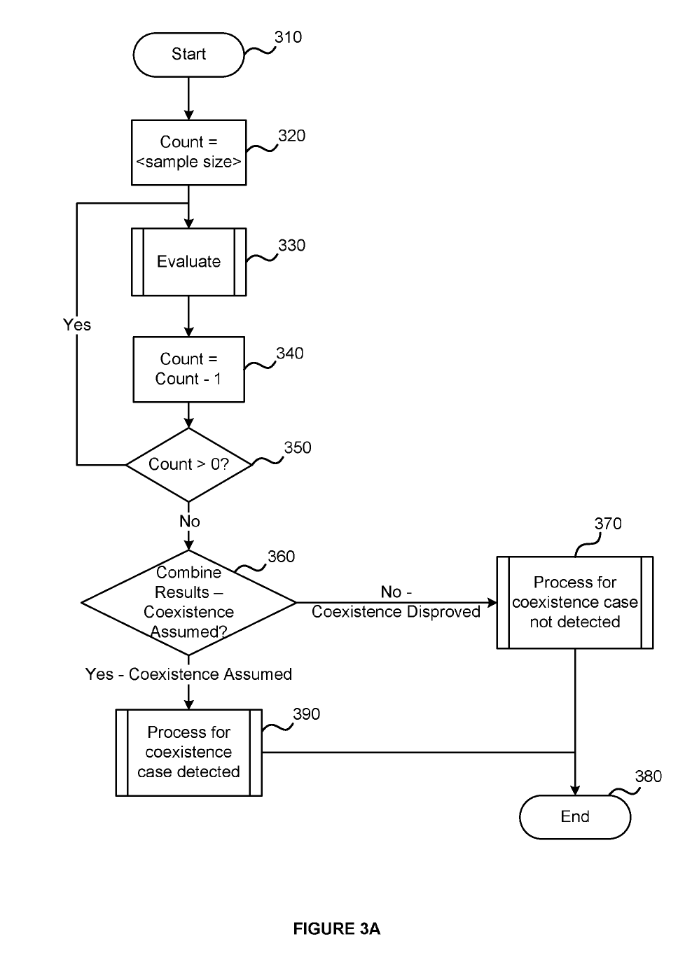

FIG. 2 shows a second example of a wireless coexistence scenario. In this example, first (Product) device 10′ device and second (Peer) device 20′ are both capable of communicating using two different wireless communication technologies, i.e., Radio 1 and Radio 2, respectively. In this wireless coexistence scenario, during simultaneous communication between the first and second devices 10′, 20′ using both Radio 1 and Radio 2, each of the first and second devices 10′, 20′ may operate a conventional wireless coexistence management mechanism. However, the operation of two coexistence management mechanisms at the same time may conflict, or otherwise lead to mutual interference between the coexistence management mechanisms, and thus may not prevent interference between the Radio 1 and Radio 2 signals, which may lead to communication problems such as data loss or corruption.

The following description sets out details of certain example implementations or embodiments of this disclosure, in which the wireless coexistence scenario of FIG. 2 is identified. In addition, action may be taken to avoid conflicts and/or interference arising with the wireless coexistence scenario of FIG. 2 due to the use of two coexistence management mechanisms (e.g., arbitration algorithms).

In particular, the following example implementations are methods that may be implemented in a first device that is communicating with at least a second, peer device. For example, the first device may comprise a vehicle head unit (e.g., media centre) comprising a module for both Wi-Fi and Bluetooth wireless communication technologies on a single or multiple chips (ICs). The Front-End configuration of the first device should allow traffic in the Rx direction to be received by both wireless communication technologies simultaneously. The second device may comprise a portable computing device such as a smart phone, tablet, laptop etc. It will be appreciated that many other applications for the method are possible and contemplated.

The methods may be performed when a coexistence management mechanism (e.g., arbitration algorithm) is active in the first device, meaning the first device is simultaneously communicating using two independent, typically different, wireless communication technologies, e.g., Wi-Fi and Bluetooth. The methods operate to perform the functional steps of: (i) determining whether a second, peer device, with which the first device is communicating, is also simultaneously communicating using the two independent communication technologies, and so also operating a coexistence management mechanism, and (ii) determining whether to change the coexistence management based on the outcome of step (i).

### Example Implementation 1

### Passive Detection

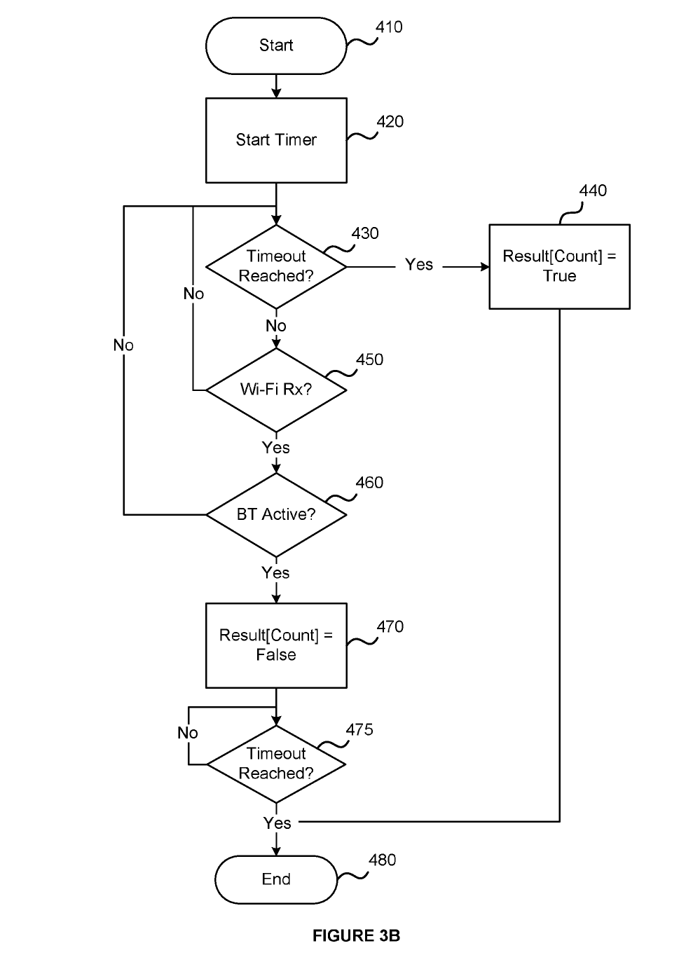

FIGS. 3A and 3B illustrate a method for identifying the wireless coexistence scenario of FIG. 2 in accordance with a first example implementation of the present disclosure. As will be appreciated from the following, the methods implementing the present disclosure are probabilistic, in the sense that they identify the probable existence of the wireless coexistence scenario of FIG. 2 according to a predetermined degree of certainty/level of confidence. In this example implementation, the technique is said to be “passive”, in the sense that the method does not actively send signals to provoke a desired response, which may be indicative of the existence (or alternatively the non-existence) of the wireless coexistence scenario.

The method of this implementation is particularly useful in applications where it is not possible, or is difficult, to distinguish between Tx and Rx packets of one of the communication technologies (e.g., Bluetooth), as explained in more detail below. In this example, the first communication technology is Wi-Fi and the second communication technology is Bluetooth.

FIG. 3A is a flow diagram, the blocks of which show the main steps of the method of this first example implementation that encompass both of the abovementioned functional steps (i) and (ii).

The method starts at block 310 and at block 320 sets an initial count corresponding to the number of detected signal samples required so as to determine wireless coexistence at the second, peer device to a predetermined degree of accuracy

In particular the initial count should represent a statistically meaningful sample size for determining the probability of the wireless coexistence scenario to an acceptable degree of certainty, whilst doing so at an acceptable speed, for the relevant application. It will be appreciated that the use of a large sample size has the advantage of greater statistical value (i.e., greater probabalistic certainty) but the disadvantage of slower determination speed. Thus, the conflicting requirement for accuracy and speed will need to balanced, depending on the application. In one example, the sample size may be 5 (five), where each signal sample is acquired over a period of 1 (one) second. Thus, the initial count corresponding to the sample size establishes a predetermined monitoring time period for signal monitoring, in this case 5 (five) seconds.

The method samples and evaluates received Wi-Fi (Rx) signals and Bluetooth signal activity (Rx/Tx signals). In particular, during the sampling period of a first signal sample, the method evaluates the sample at block 330, using an “Evaluate Function”, to determine whether the signal sample indicates wireless coexistence at the second, peer device. The Evaluate Function block 330 of this example implementation is described in further detail below with reference to FIG. 3B. It will be appreciated that whilst in this example implementation sampling and evaluation is performed substantially in real time, in other example implementations the samples may be stored and evaluated at a later time.

At block 340, the method decrements the count by one, and at block 350 determines if the count is greater than zero. If the count is greater than zero, the method returns to block 330 for evaluating the next sample. If the count is not greater than zero (i.e., equal to zero), then the required number of signal samples (corresponding to the initial count/sample size) has been evaluated and the method proceeds to block 360.

At block 360 the method combines the evaluation results for all of the evaluated signal samples and determines whether wireless coexistence in the second, peer device is “assumed” (statistically probable) or “disproved” (statistically disproved). In particular, wireless coexistence is disproved if some or all of the evaluated signals samples indicate that there is no wireless coexistence in the second, peer device. On the other hand, wireless coexistence is assumed (i.e., coexistence is statistically probable) if a predetermined number or proportion of the evaluated signal samples, typically 100% of the signal samples, indicate that wireless coexistence in the second, peer device is not disproved. It will be appreciated that the number or proportion of signal sample results for a determination that the wireless coexistence scenario exists (or not) will be dependent on the level of confidence/certainty required for the particular application.

If, on the one hand, the result of the determination in block 360 is “coexistence disproved”, the method proceeds to block 370 in which the method performs predetermined processing for the case where there is no wireless coexistence in the second, peer device and the method ends at block 380. For example, block 370 may continue to operate the wireless coexistence management mechanism (e.g., arbitration algorithm) in the first device. If, on the other hand, the result of the determination in block 360 is “coexistence assumed”, the method proceeds to block 390 in which the method performs predetermined processing for the case where there is wireless coexistence in the second, peer device. For example, block 390 may switch off the wireless coexistence management mechanism (e.g., arbitration algorithm) in the first device (or, alternatively, in the second device), or the coexistence management may otherwise be changed, so as to prevent conflict and/or interference between the wireless coexistence mechanisms operating on the first and second devices. Thereafter, the method ends at block 380.

FIG. 3B is a flow diagram, the blocks of which show the steps of the “Evaluate Function” of this example implementation that may be performed at block 330 of FIG. 3A. As previously mentioned, the Evaluate Function evaluates the Wi-Fi Rx and Bluetooth (Rx/Tx) signals during each sampling period over the predetermined monitoring time period. As will be appreciated from the following description, the Evaluate Function is able to disprove the wireless coexistence scenario of FIG. 2, by detecting two simultaneous Rx signals using the two independent communication technologies. It will be appreciated that, in this disclosure, the term “simultaneous signals” is not intended to be limited to signals at exactly the same time, but rather refers to signals occurring in the same timeslot or immediately adjacent timeslots.

The method starts at block 410 and at block 420 starts a timer, which is set to run for a predetermined time period. The method proceeds to block 430, which determines whether the timer has reached timeout (i.e., the timer has run for the predetermined time period, and thus expired). If the timer has timed out, the method sets the value for wireless coexistence as “true” indicating that the wireless coexistence scenario of FIG. 2 is not disproved and ends at block 480 with the final evaluation result as “true”. Alternatively, if the timer has not timed out, the method proceeds to block 450.

At block 450, the method determines whether the signal sample includes a received signal in accordance with a first wireless communication technology, such as Wi-Fi. If block 450 determines that no Wi-Fi Rx signal is present, the method returns to block 430. However, if block 450 determines that a Wi-Fi Rx signal is present in the signal sample, the method proceeds to block 460.

At block 460, the method determines whether the signal sample indicates signal activity using a second wireless communication technology, such as Bluetooth. For example, the method may determine whether the sample includes a transmitted and/or received signal in accordance with the second wireless communication technology during a predefined time slot, such as a combined transmit/receive (Tx/Rx) time slot of the second wireless communication technology. If block 460 determines that the second wireless communication technology is not active, the method returns to block 430. However, if block 460 determines that the second wireless communication technology is active, then simultaneous Rx Wi-Fi and Rx/Tx Bluetooth signals are detected, thereby disproving the wireless coexistence scenario of FIG. 2. Accordingly, the method proceeds to block 470, which sets the value for wireless coexistence to “false”. The method then proceeds to block 475, which determines whether the timer has reached timeout (i.e., the timer has run for the predetermined time period, and thus expired). If the timer has timed out, the method proceeds to block 480, otherwise the method repeats block 475. The method then ends at block 480 with the final evaluation result as “false”.

Since block 460 merely determines whether the second wireless communication technology is active, the method of this example implementation can be used in applications, in which it is not possible to distinguish between Tx and Rx packets. For example, IEEE 802.15.2-2003 PTA schemes occasionally may be implemented as PIO signalling schemes with a single PIO indicating Bluetooth Rx and Tx activity, without supplying all the specified information in IEEE 802.15.2-2003. In this case the PTA scheme will not be able to easily differentiate between Tx and Rx Bluetooth signals.

It will be appreciated that various modifications may be made to the method of the example implementation of FIGS. 3A and 3B. For example, the method may be implemented to identify the wireless coexistence scenario of FIG. 2 with wireless communication technologies other than Wi-Fi and Bluetooth.

### Example Implementation 2

### Passive Detection (Alternative)

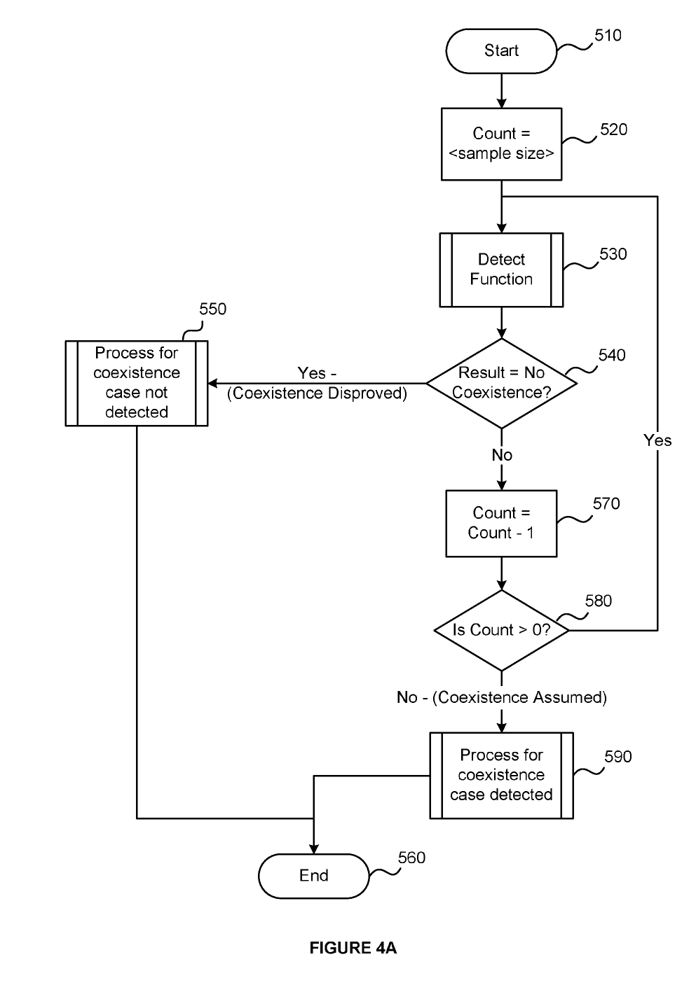

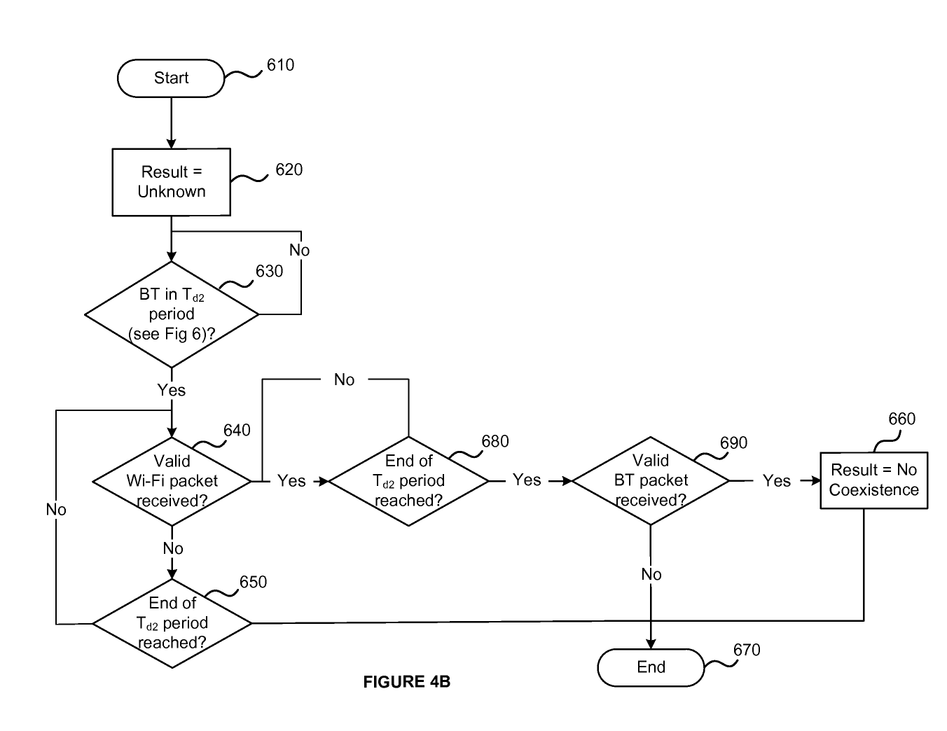

FIGS. 4A and 4B illustrate an alternative method for identifying the wireless coexistence scenario of FIG. 2 in accordance with a second, passive example implementation of the present disclosure. Similar to the example implementation of FIGS. 3A and 3B, the second example implementation is passive (i.e., it merely monitors signal samples communicated between the first device and the second, peer device and does not actively send signals to provoke a desired response). However, in this example, the method is capable of distinguishing between transmitted (TX) and received (Rx) signals in accordance with the second wireless communications technology. As in the example implementation of FIGS. 3A and 3B, in this example the first communication technology is Wi-Fi and the second communication technology is Bluetooth.

FIG. 4A is a flow diagram, the blocks of which show the main steps of the method of this second example implementation that encompass both of the functional steps (i) and (ii) set out above.

The method starts at block 510 and at block 520 sets an initial count corresponding to the number of signal samples required to determine the probability of the wireless coexistence scenario of FIG. 2 to a predetermined degree of certainty/level of confidence. The initial count may be determined using techniques similar to those described above in relation to block 320 of FIG. 3A. In the method of this implementation, 100% of the signal samples must indicate that the wireless coexistence scenario may exist (i.e., is not disproved). In other implementations, the proportion of such examples may be less than 100%. Thus, the initial count may be a minimum number of samples necessary to lead to a determination that the wireless coexistence scenario of FIG. 2 is probable to the predetermined degree of certainty.

The method samples and evaluates received Wi-Fi (Rx) signals and Bluetooth (Rx) signals. In particular, during the sampling period of a first signal sample, the method performs evaluation using a “Detect Function” at block 530 to determine whether the signal sample indicates that there is no wireless coexistence at the second, peer device (i.e., the wireless coexistence scenario of FIG. 2 is disproved). The Detect Function block 530 of this example implementation is described in further detail below with reference to FIG. 4B. It will be appreciated that whilst in this example implementation sampling and evaluation using the “Detect Function” is performed substantially in real time, in other example implementations the samples may be stored and evaluated at a later time.

At block 540, the method determines whether the Detect Function indicates that there is no wireless coexistence in the second, peer device. If block 540 determines that there is no wireless coexistence, then the wireless coexistence scenario is disproved and the method proceeds to block 550, in which the method performs predetermined processing for the case where there is no wireless coexistence in the second, peer device and the method ends at block 560. However, if block 540 determines that there may be wireless coexistence in the second, peer device (i.e, the result of the Detect Function is “unknown”, as described below), the method proceeds to block 570.

At block 570, the method decrements the count by one, and at block 580 determines if the count is greater than zero. If the count is greater than zero, the method returns to block 530 for performing the Detect Function on the next signal sample. If the count is not greater than zero (i.e., equal to zero), then the required number of signal samples (corresponding to the initial count) have been evaluated and, in each case, the evaluation determined that there may be wireless coexistence in the second, peer device (i.e., the result of the Detect Function is “unknown”). Accordingly, the method determines that coexistence is statistically probable and proceeds to block 590. At block 590, the method performs predetermined processing for the case where there is wireless coexistence in the second, peer device, and, thereafter, the method ends at block 580.

It is understood that the predetermined processing performed in blocks 550 and 590 may be similar to the processing performed in blocks 370 and 390, respectively, of FIG. 3A of the first example implementation.

FIG. 4B is a flow diagram, the blocks of which show the steps of the Detect Function of the example implementation that may be performed at block 530 of FIG. 4A. The Detect Function evaluates the signal samples by detecting the presence of signals in a specific, individual time slot, also called the “trigger period” herein, of the signal sample. It will be appreciated that the time slots of the signal samples are predefined by, and will be dependent upon, the particular communication protocol implemented in the application in accordance with the corresponding wireless communication technology.

As shown in FIG. 4B, the method starts at block 610 and at block 620 sets the result as “unknown”. The detect function then monitors the signal samples, received by the first device, over a predetermined time period.

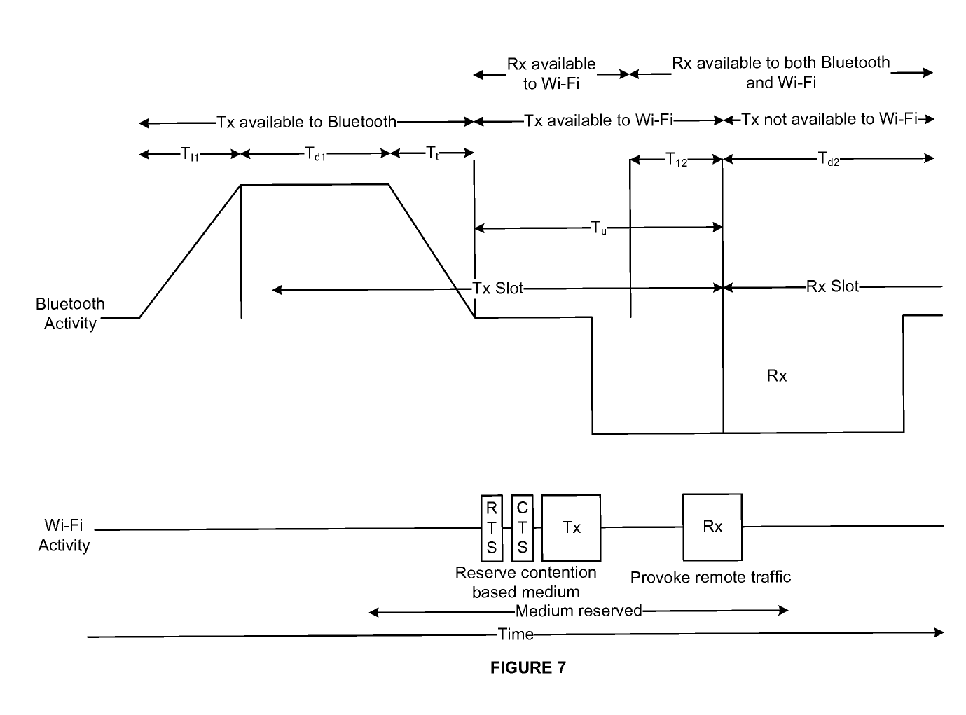

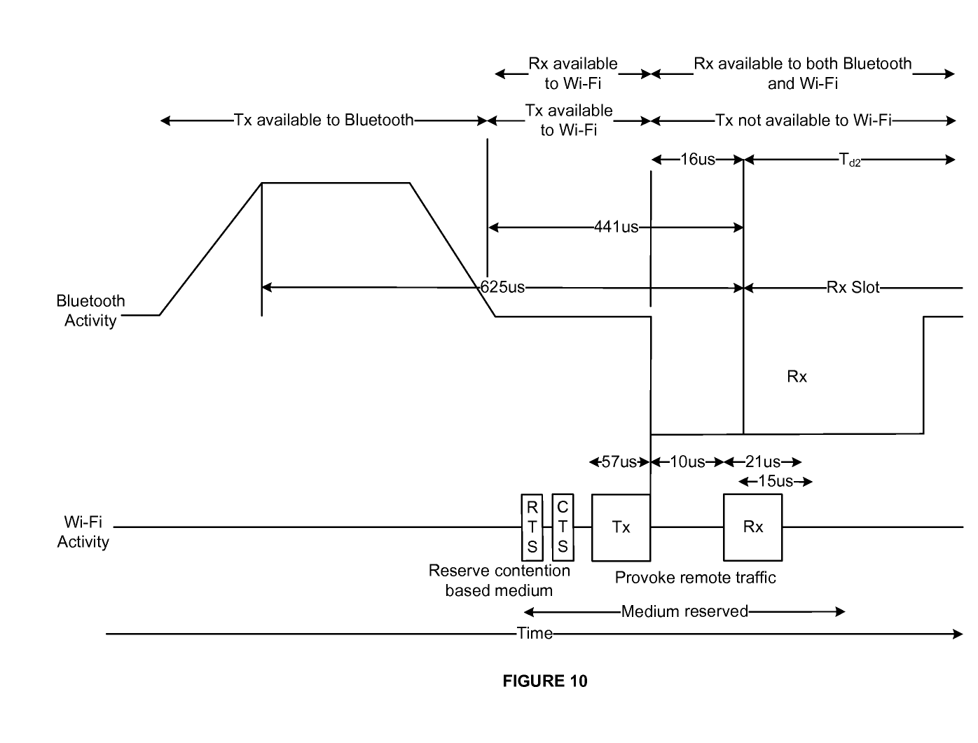

In particular, it will be understood that the first and second wireless communication technologies may utilise predefined time slots to transmit and receive signals using the first and second wireless communication technologies in accordance with a time-domain based coexistence scheme. Examples of this are illustrated in FIGS. 7, 9 and 10, which depict the signal time slots of various coexisting Rx and Tx signals in accordance with Wi-Fi and Bluetooth communication technologies operating in the 2.4 GHz frequency band, as described in further detail below.

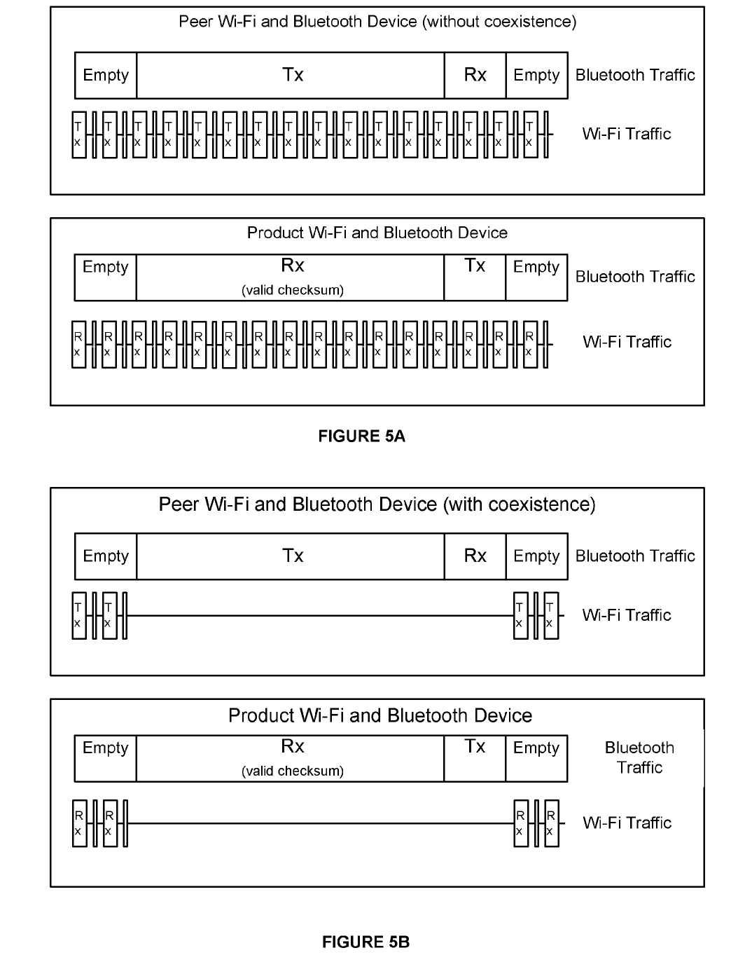

FIG. 5A is a schematic diagram of typical traffic signals communicated in accordance with the scenario of FIG. 1 in which the first device (Product) communicates with second and third (Peer) devices using Bluetooth and Wi-Fi communication technologies, respectively. The signals shown in FIG. 5A include two simultaneous transmit/receive (Tx/Rx) packets using Wi-Fi and Bluetooth, signifying that two different (second and third Peer) devices are transmitting simultaneously and there is no wireless coexistence management mechanism operating in a single device at the Peer end of the communications.

FIG. 5B is a schematic diagram of typical traffic signals communicated by a first device (Product) and a second device (Peer) in a time-domain based coexistence scheme implementing Wi-Fi and Bluetooth communication technologies in accordance with the scenario of FIG. 2. In this case, Wi-Fi transmit/receive (Tx/Rx) packets are time separated from the Bluetooth transmit/receive (Tx/Rx) packets, and the time-domain based wireless coexistence scheme of FIG. 2 may be present, requiring a wireless coexistence management mechanism operating in a single device at the Peer end of the communications.

Accordingly, the first device may monitor the Wi-Fi and Bluetooth traffic signals during a Bluetooth Rx slot (shown in the bottom half of FIG. 5A/5B). If, during this Bluetooth Rx slot, valid Wi-Fi Rx traffic as well as valid Bluetooth traffic is present then it can be concluded that no wireless coexistence management mechanism (e.g., arbitration algorithm) is operating in the second and third (Peer) devices.

Returning to FIG. 4B, at block 630 the method waits for the Bluetooth Rx time slot (Td2) to start. If block 630 determines that the time period Td2 has started, the method proceeds to block 640. Block 640 determines if a valid Wi-Fi packet has been received. If block 640 determines that a valid Wi-Fi packet has not been received, the method proceeds to block 650. Block 650 determines if the end of the Bluetooth Rx slot (Td2) has been reached. If block 650 determines that Td2 has not been reached then the method returns to block 640, otherwise the method ends at block 670 with the result remaining as “unknown”.

If block 640 determines that a valid Wi-Fi packet has been received, the method proceeds to block 680. Block 680 determines whether the Bluetooth Rx time slot (Td2) has expired. If the Bluetooth Rx time slot has not expired, the method repeats block 680 until the Bluetooth Rx time slot has expired. When block 680 determines that the Bluetooth Rx time slot (Td2) has expired, the method proceeds to block 690.

At block 690, the method determines whether the Bluetooth packet is valid after expiry of the Bluetooth Rx time slot (Td2). It will be understood that validity may be determined through the use of a checksum or the similar error detection technique. If block 690 determines that the Bluetooth packet is not valid, the method ends at block 670, with the result remaining as “unknown”. However, if block 690 determines that the Bluetooth packet is valid, the method proceeds to block 660, which sets the result to “no coexistence” and the method ends at block 670.

It will be appreciated that various modifications may be made to the method of the example implementation of FIGS. 4A and 4B.

In view of their “passive” approach, for identifying the wireless coexistence scenario of FIG. 2, the first and second example implementations rely on the second Peer device scheduling concurrent, time-domain separated, WiFi and Bluetooth traffic, which is probabilistic. Thus, these implementations may be successfully realised in applications and/or situations where there is a high level of active communications using both wireless communication technologies such that concurrent scheduling is likely. However, in some applications and/or situations, particular those in which speed of detection of the wireless coexistence scenario of FIG. 2 is important, an “active” approach, that provokes the second Peer device into such concurrent scheduling and transmission, may be beneficial. An example of such an active implementation is described below.

### Example Implementation 3

### Active Detection

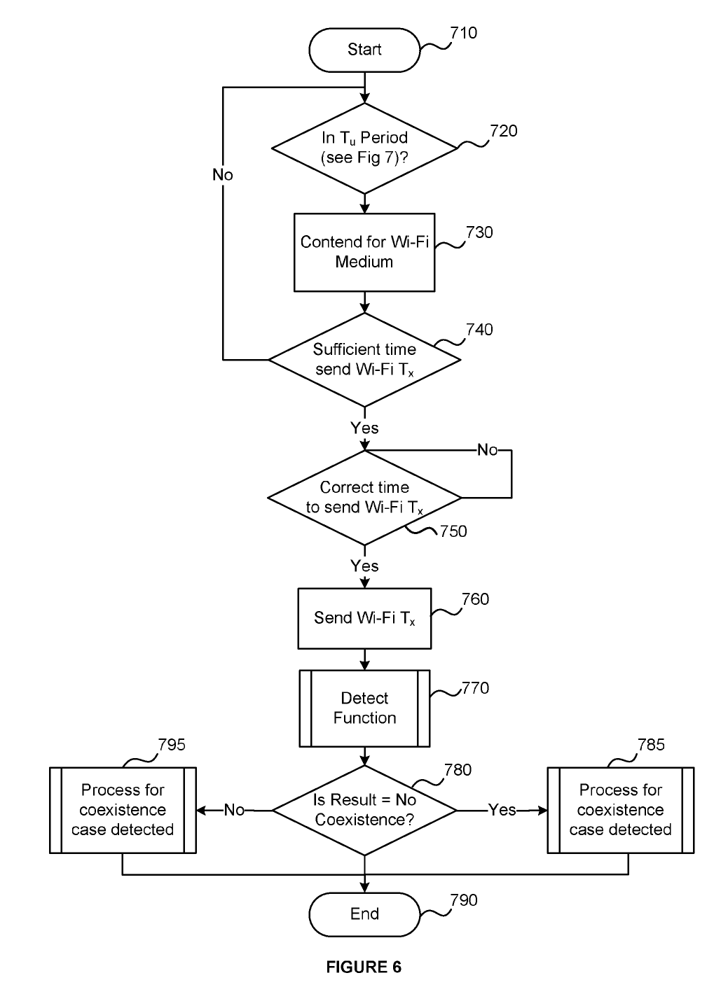

FIG. 6 is a flow diagram, the blocks of which show the main steps of the method of this third, active example implementation that encompass both of the functional steps (i) and (ii) described above. As in the methods of the first and second example implementations, the first wireless communication technology is Wi-Fi and the second communication technology is Bluetooth. In this active technique, the method actively initiates or provokes communications from a Peer device in order to detect signals indicative of the wireless coexistence scenario of FIG. 2 and, thus, determine the existence of the scenario to a greater degree of certainty and/or more quickly by processing a smaller number of samples (typically just one, as described below). In particular, as described below, the method actively sends a relatively small, Wi-Fi Tx packet at a precisely controlled time during the Wi-Fi and Bluetooth timeslots to provoke a response, thereby increasing the probability of the simultaneous transmission of Wi-Fi and Bluetooth signals from a single or multiple peer devices.

The method starts a block 710 and at block 720 determines when the current time is in a time interval in the Bluetooth slot pattern that allows transmission of a Wi-Fi Tx packet without interfering with Bluetooth RF signals. As described in further detail below with reference to FIG. 7, a suitable time interval is the unused time, Tu, at the end of the Bluetooth Tx time slot. When block 720 determines a current time interval to allow the Wi-Fi Tx packet to be transmitted, at block 730 the method contends for the Wi-Fi medium. An example of this is described in further detail below with reference to FIG. 7, in which the Wi-Fi medium may be reserved for the transmission. At block 740, the method determines whether there is sufficient time to send a Wi-Fi transmit (Tx) packet. If block 740 determines that there is insufficient time to send a Wi-Fi Tx packet, the method returns to block 720, thereby waiting for the next Wi-Fi Tx timeslot. On the other hand, if block 740 determines that there is sufficient time to send a Wi-Fi Tx packet, the method proceeds to block 750.

At block 750, the method determines when it is a correct time to send the Wi-Fi Tx packet. An example of this is described in further detail below in relation to FIG. 7. When block 750 determines that it is the correct time to send the Wi-Fi Tx packet, the method proceeds to block 760 in which the Wi-Fi Tx packet is sent.

The method then proceeds to monitor the Wi-Fi and Bluetooth traffic signals. In particular the method evaluates a first received signal sample using a Detect Function at block 770 for determining whether the signal sample indicates that there is no wireless coexistence at the second, peer device. The Detect Function of block 770 of this example implementation may be as described above in relation to the second, passive implementation with reference to FIG. 4B. It will be appreciated that whilst the Detect Function may implement the same or similar steps as used in the second, passive example implementation of FIG. 4B, in this third, active example implementation, the likelihood of the Wi-Fi Rx event happening, in a manner that enables the scenario of FIG. 2 to be disproved, has been increased. Thus, the outcome of the active example implementation has a greater degree of certainty compared to the passive example implementations.

Once the Detect Function block 770 provides a result, at block 780 the method determines whether the Detect Function result is that there is no wireless coexistence in the second, peer device. If block 780 determines that there is no wireless coexistence, then the method proceeds to block 785, in which the method performs predetermined processing for the case where there is no wireless coexistence in the second, peer device and the method ends at block 790.

However, if block 780 determines that the Detect Function result is that there may be wireless coexistence in the second, peer device (i.e., the result is “unknown”) the method proceeds to block 795, in which the method performs predetermined processing for the case where there is wireless coexistence in the second, peer device, and, thereafter, the method ends at block 790.

It is understood that the predetermined processing performed in blocks 785 and 795 may be similar to the processing performed in blocks 370 and 390, respectively, of FIG. 3A of the first example implementation.

In addition to the greater degree of certainty of the outcome resulting from the use of this active example implementation, compared to the passive example implementations described above, it has the additional advantage of determining a result more quickly. In particular, the method of FIG. 6 merely evaluates a single sample. Provided that the Wi-Fi signal is successfully transmitted at the correct time, this approach should provide a result with an acceptable degree of certainty. It will be appreciated that, in other active example implementations, the method of FIG. 6 may be repeated to evaluate one or more further signal samples, in the event that the result of the Detect Function at block 770 on the first signal sample is “unknown”, so as to increase the degree of certainty that the wireless coexistence scenario of FIG. 2 exists.

It will be appreciated that various modifications may be made to the method of the example implementation of FIG. 6.

FIG. 7 is a timing diagram showing the timeslots of example typical Bluetooth and Wi-Fi traffic signals communicated by a first device (Product) comprising an IEEE 802.11 STA and a second device (Peer) comprising an IEEE 802.11 Access Point, in accordance with the method of FIG. 6. It will be appreciated that the sequence, values etc., of the Bluetooth and Wi-Fi Tx/Rx timeslots will vary with other example applications, and may even be dependent on the choice of vendor hardware (chips) employed.

The example of FIG. 7 shows Bluetooth (the top trace) as master of a link but this method should apply equally well when running as slave of a link.

Bluetooth is based around 625 μs (Tx and Rx) timeslots so the first, Bluetooth Tx slot shown in FIG. 7 comprises:

625 μs=Tl1+Td1+Tt+Tu

Where:
Tl1 is the lead time to allow the Bluetooth radio to ramp up and become ready to transmit (comprising the radio ramp and unmodulated carrier)
Td1 is the time spent transmitting the data packet and training sequence
Tt is the tail time to allow ramping down of the Bluetooth radio
Tu is the unused time at the end of the slot.

Thus, the unused time Tu at the end of the Bluetooth Tx timeslot may be used to transmit a Wi-Fi Tx packet to provoke a response from the peer device. A relatively small Tx data packet, such as a poll or NULL packet, can be used in order to elicit data from a peer device such that it can be assumed that Td1 is quite small, approximately 128ρs. Average values for Tl1 and Tt are approximately 40 μs for Tl1 and in the region of 16 μs for Tt.

Therefore:

Tu=625 μs−Tl1−Td1−Tt

Tu=441 μs

The Bluetooth Rx slot of FIG. 7 can be divided into two parts for the purposes of this example, namely:
Tl2 is the lead time taken to switch the Bluetooth radio to Rx, and
Td2 is the time taken to receive the data packet

The timing diagram of FIG. 7 is based on the use of Bluetooth products of the applicant, Cambridge Silicon Radio Limited, on the basis of which it can be further assumed that Tl2 is in the region of 16 μs. Therefore the time available for Wi-Fi to Tx before starting the Bluetooth Rx slot activity will be 429 μs.

Between Tu-Tl2 is will be possible to transmit and receive Wi-Fi traffic. Thus, the time Tl2 may also be available to transmit, or continue to transmit, a Wi-Fi Tx packet (e.g., NULL packet) to provoke a response from the peer device, i.e., Wi-Fi Rx packet (e.g., ACK packet). During Tl2 and Td2 it will be possible to receive Wi-Fi traffic. It is assumed that some coexistence solutions may take opportunity of Wi-Fi activity during Tu and Tl2.

Thus, in this example, the time interval Td2 is considered to be the “trigger period”, this being the time slot in which it is expected that a response from the peer device will be received in the case of the scenario of FIG. 1 (i.e., the scenario of FIG. 2 is disproved). To provoke Wi-Fi Rx traffic from a peer device during Td2, the correct time to send out a Tx packet, such as a NULL packet, should be just before Tl2 starts (i.e., during Tu). FIG. 7 shows an example of this Wi-Fi activity (the bottom trace).

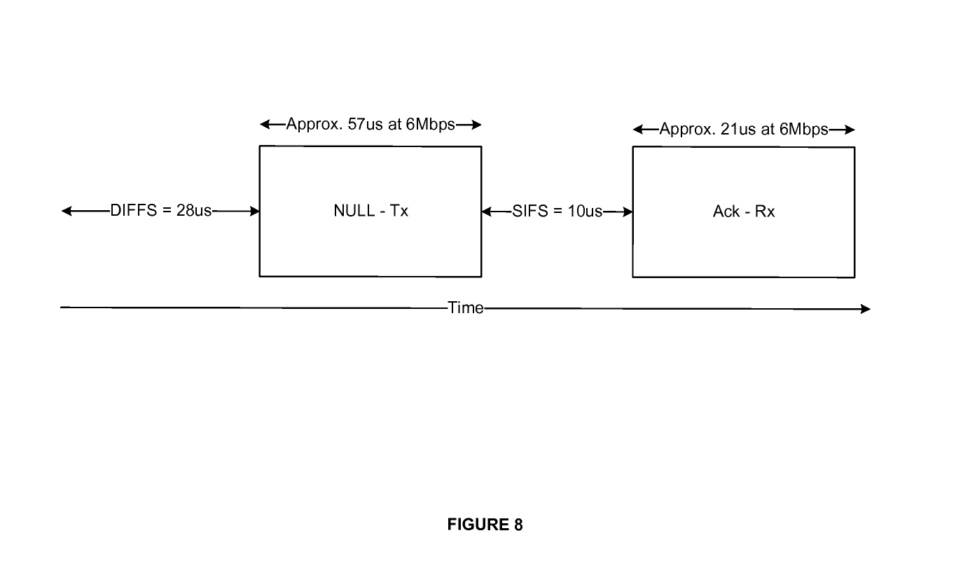

The timings of an average NULL/ACK exchange are given in FIG. 8. This example is based around IEEE 802.11g and using the lowest IEEE 802.11g modulation rate, so that the packet sizes and timings involved work together with the timings set out above. By selecting a lower modulation rate, the data exchanges are longer and overlap with Td2 rather than the ACK being received in Tl2.

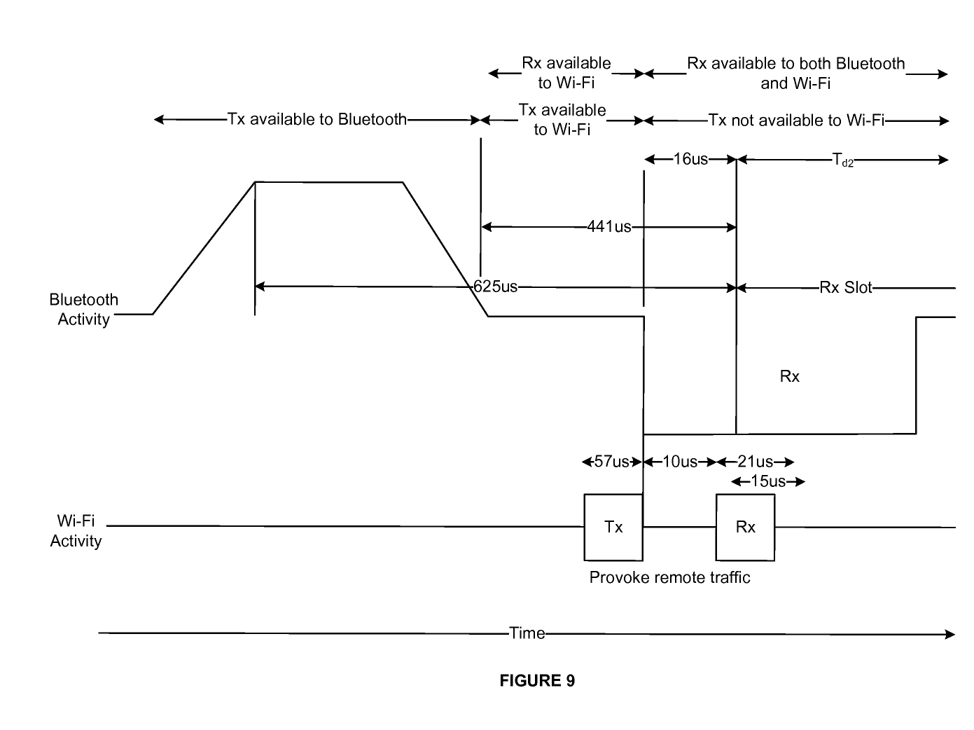

A full example of all the timings involved in the example of FIG. 7 is shown in FIG. 9. It will be appreciated that in other implementations, the timings may differ significantly from those illustrated according to the application (wireless communication technologies) and the type of Tx packet chosen to provoke a response. However, in all cases, there will be a period corresponding to the described “trigger period” Td2, in which signals may be received in accordance with the first and second communication technologies (i.e., the scenario of FIG. 2 is disproved), and a time period, corresponding to the described unused time period Tu, before the “trigger period”, in which the Tx packet can be transmitted. The determination of whether there is sufficient time in block 740 of FIG. 6 and the determination of the correct time in block 750 of FIG. 6, both of which are carried out during the time period Tu, will depend on multiple factors including the length of the relevant time periods (Tu and Td2), the time between transmitting the Tx packet and receiving the Rx packet in response etc.

It will be appreciated that the method of each of the above-described example implementations 1 to 3 may be typically carried out in software but optionally in firmware or hardware, in any suitable electronic communications device. Thus, the disclosure encompasses a computer readable medium comprising instructions that, when executed by a processor, perform the above described method.

Advantageously, the methods performed by the first device according to the present disclosure permit determination of the probable existence of the wireless coexistence scenario of FIG. 2 independent of the type and vendor of the other, peer devices. Typically, the determination of the probable existence of the wireless coexistence scenario triggers a wireless coexistence management process solely within the first device, and thus also independent of the type and vendor of the other, peer devices.

It will be understood that the above description of example implementations of the disclosure is given by way of example only and that various modifications may be made by those skilled in the art. For example, whilst the implementations have been described in relation to specific wireless communication technologies, the method of the disclosure may be applied using other wireless communication technologies that give rise to wireless coexistence scenarios. Although various implementations have been described above with a certain degree of particularity, or with reference to one or more individual example implementations and techniques, those skilled in the art could make numerous alterations to the implementation disclosed without departing from the spirit or scope of the invention.

The applicant hereby discloses in isolation each individual feature described herein and any combination of two or more such features, to the extent that such features or combinations are capable of being carried out based on the present disclosure as a whole in light of the common general knowledge of the skilled person, irrespective of whether such features or combination of features solve any problems disclosed herein. The applicant indicates that aspects of the invention may consist of any such individual feature or combination of features.

1. A method for wireless coexistence management, the method performed using a first device and comprising the steps of:
monitoring signal samples of communications in accordance with first and second independent wireless communication technologies over a predetermined time period, the monitored signal samples comprising samples of wireless communications between the first device and at least one peer device;
processing the monitored signal samples to determine whether the monitored communications indicate a probable existence of a wireless coexistence scenario, in which the first device is communicating with a single peer device in accordance with both the first and second wireless communication technologies, and
if the step of processing the monitored signal samples determines that the monitored communications indicate the probable existence of the wireless coexistence scenario, triggering a wireless coexistence management process.

2. The method as claimed in claim 1, wherein the wireless coexistence management process comprises changing the wireless coexistence management process operating in the first device, the peer device or both in order to prevent wireless coexistence problems.

3. The method as claimed in claim 2, wherein the step of changing the wireless coexistence management process comprises:
switching off the wireless coexistence mechanism in the first device, or
signalling the peer device using the first or second wireless communication technology in order to coordinate the wireless coexistence management mechanisms in the first device and the peer device.

4. The method as claimed in claim 1, further comprising the steps of:
prior to the step of monitoring the signal samples, transmitting a signal in accordance with the first communication technology in order to provoke a response from at least one peer device.

5. The method as claimed in claim 4, comprising timing the transmission of the signal in accordance with the first communication technology so that a response from at least one peer device is received during a known time slot for signals received in accordance with the second communication technology.

6. The method as claimed in claim 1, wherein the step of processing the monitored signal samples to determine whether the monitored communications indicate the probable existence of the wireless coexistence scenario comprises:
sampling signals of communications in accordance with the first and second wireless communication technologies for a predetermined time period, each signal sample comprising signals communicated during a predefined sampling period; and
for each signal sample:
determining whether a valid received (Rx) signal in accordance with the first wireless communication technology is communicated during a predefined time slot of the sampling period;
determining whether a valid transmitted or received (Tx/Rx) signal in accordance with the second wireless communication technology is communicated during the predefined time slot of the sampling period, and
if it is determined that both a valid received (Rx) signal in accordance with the first wireless communication technology and a valid transmitted or received (Tx/Rx) signal in accordance with the second wireless communication technology are communicated during the predefined sampling period, determining that the monitored communications do not indicate the probable existence of the wireless coexistence scenario.

7. The method as claimed in claim 6, further comprising the steps of:
prior to the step of monitoring signal samples, determining the predetermined time period for sampling a selected number of signal samples to be processed in order to indicate the probable existence of the wireless coexistence scenario to a predetermined degree of certainty, wherein:
if, for a predetermined proportion of the selected number of signal samples, it is not determined that both a valid received (Rx) signal in accordance with the first wireless communication technology and a valid transmitted or received (Tx/Rx) signal in accordance with the second wireless communication technology are communicated during the predefined sampling period, determining that the monitored communications indicate the probable existence of the wireless coexistence scenario to the predetermined degree of certainty.

8. The method as claimed in claim 6, wherein the predefined time slot of the sampling period comprises a known receive (Rx) time slot for signals communicated in accordance with the second wireless communications technology.

9. The method as claimed in claim 6, wherein:
prior to the step of sampling signals, transmitting a signal in accordance with the first communication technology in order to provoke a response from at least one peer device.

10. The method as claimed in claim 9, further comprising the steps of:
prior to the step of transmitting a signal in accordance with the first communication technology:
identifying a time slot for the transmission of the signal;
determining whether there is sufficient time to send the signal within the identified time slot, and
if it is determined that there is sufficient time to send the signal, determining a correct time for transmitting the signal;
wherein the step of transmitting a signal in accordance with the first communication technology is performed at the determined correct time so that a response from at least one peer device is received during the predefined time slot of the sampling period.

11. The method as claimed in claim 9, wherein:
prior to the step of transmitting a signal in accordance with the first communication technology, the method comprises the step of:
contending for a transmission medium for communications in accordance with the first communication technology.

12. The method as claimed in claim 11, wherein the step of contending for a transmission medium comprises reserving the transmission medium for a desired time period.

13. The method of claim 1, wherein the first wireless communication technology comprises Wi-Fi and the second wireless communication technology comprises Bluetooth.

14. The method of claim 4, wherein transmitting a signal in accordance with the first wireless communication technology comprises transmitting a NULL packet or similar packet, in accordance with the second communication technology.

15. A method for determining a probable existence of a wireless coexistence scenario, in which two devices are communicating with each other using first and second independent wireless communication technologies, the method performed using a first device and comprising the steps of:
sampling signals in accordance with the first and second wireless communication technologies for a predetermined time period, each signal sample comprising signals communicated during a predefined sampling period; and
for each signal sample:
determining whether a valid received (Rx) signal in accordance with the first wireless communication technology is communicated during a predefined time slot of the sampling period;
determining whether a valid transmitted or received (Tx/Rx) signal in accordance with the second wireless communication technology is communicated during the predefined time slot of the sampling period, and
if it is determined that both a valid received (Rx) signal in accordance with the first wireless communication technology and a valid transmitted or received (Tx/Rx) signal in accordance with the second wireless communication technology are communicated during the predefined sampling period, determining that the sampled signals do not indicate the probable existence of the wireless coexistence scenario.

16. A method for detecting a wireless coexistence scenario, in which two devices are communicating with each other using first and second independent wireless communication technologies, the method performed using a first device and comprising the steps of:
selecting a number of signal samples for determining the probable existence of the wireless coexistence scenario to a predetermined degree of certainty;
monitoring received (Rx) signals in accordance with the first communication technology and received (Rx) signals, or both transmitted (Tx) and received (Rx) signals, in accordance with the second communication technology so as to sample the selected number of signal samples over a predetermined time period;
for each signal sample:
evaluating the signal sample to determine whether or not both a valid received (Rx) signal in accordance with the first wireless communication technology and a valid received (Rx) signal in accordance with the second wireless communication technology are received during a predefined time slot in the predetermined time period;
wherein, if, for a predetermined proportion of the selected number of signal samples, it is not determined that both a valid received (Rx) signal in accordance with the first wireless communication technology and a valid received (Rx) signal in accordance with the second wireless communication technology are received during the predefined time slot in the predetermined time period, determining that the monitored signals indicate the probable existence of the wireless coexistence scenario to the predetermined degree of certainty.

17. The method as claimed in claim 16, wherein the predefined time slot of the predetermined time period comprises:
a receive (Rx) time slot for signals communicated in accordance with the second wireless communications technology, or
a time slot comprising both a transmit (Tx) time slot and a contiguous receive (Rx) time slot for signals communicated in accordance with the second wireless communications technology.

18. The method for detecting a wireless coexistence scenario as claimed in claim 16, further comprising:
prior to the step of monitoring received (Rx) signals in accordance with the first communication technology, transmitting a signal in accordance with the first communication technology, wherein the signal is transmitted in order to provoke a response from at least one peer device and at a time so that the response is received during the predefined time slot of the predetermined time period of the signal samples.
